(19) United States
(12) Patent Application Publication
(10) Pub. No.: US 2006/0193138 A1
(43) Pub. Date: Aug. 31, 2006

(54) Light shield

(76) Inventor: Vincent Montefusco, Crowley Lake, CA (US)

Correspondence Address: STEPHEN CHRISTOPHER SWIFT;SWIFT LAW OFFICE, SUITE 600, 1800 DIAGONAL ROAD, ALEXANDRIA, VA, 22314-2840, US

(21) Appl. No.: 11/066,823

(22) Filed: Feb. 28, 2005

(51) Int. Cl. F21V 11/00

(52) U.S. Cl. 362/359; 362/433

(57) ABSTRACT

Light shield having a frustum-conical shaped portion having first and second ends and a cone shaped portion having first and second ends, the first end of the cone shaped portion being formed integral with one end of the first portion of the shield. A clamp strap, integral with the frustum-conical and cone shaped portions, is provided adjacent the second end of the cone shaped portion to secure the light shield to the fixture.

### BACKGROUND OF THE INVENTION

1. Field of the Invention

The present invention provides a shield device that mounts to a light fixture for focusing and controlling the direction of light emitted from the fixture.

2. Description of the Prior Art

Light shields, or reflectors, for focusing and controlling the direction of the light emitted from a light source have been available in the prior art. The prior art shields tend to be relatively expensive and limited for use with a specific fixture.

What is thus desired is to provide a light fixture that is inexpensive and can be adapted to be used with a variety of light fixtures.

### SUMMARY OF THE INVENTION

The present invention provides a light shield having a frustum-conical shaped portion having first and second ends and a cone shaped portion having first and second ends, the first end of the cone shaped member being formed integral with one end of the first portion of the shield. A clamp strap , integral with the frustum-conical and cone shaped portions, is provided adjacent the second end of the cone shaped portion to secure the light shield to the fixture.

### DESCRIPTION OF THE DRAWINGS

For a better understanding of the present invention as well as other objects and further features thereof, reference is made to the following description which is to be read in conjunction with the accompanying drawing therein:

FIG. 1 is a right side elevational view of the light shield of the present invention;

FIG. 2 is a left side elevational view of the light shield of the present invention;

FIG. 3 is a bottom view of the light shield of the present invention;

FIG. 4 is a top view of the light shield of the present invention;

FIG. 5 is a front view of the light shield of the present invention;

FIG. 6 is a rear view of the light shield of the present invention; and

FIG. 7 is a sectional view along line 7-7 of FIG. 4.

### DESCRIPTION OF THE INVENTION

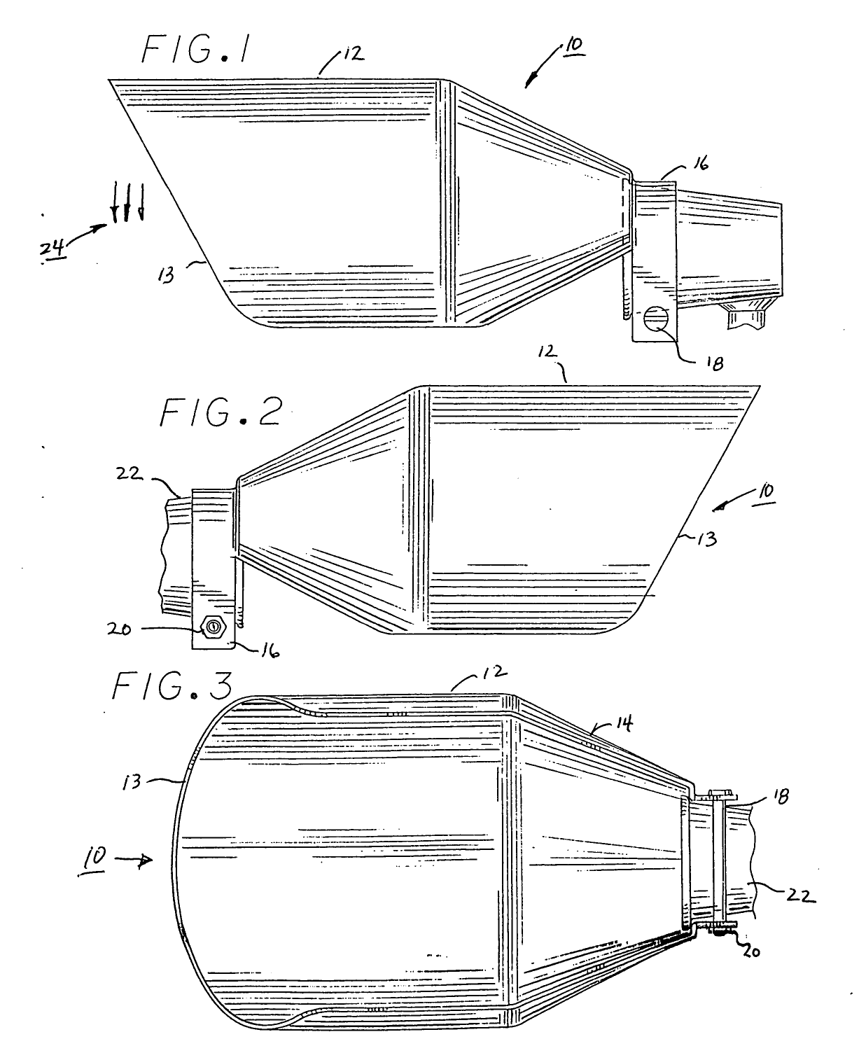

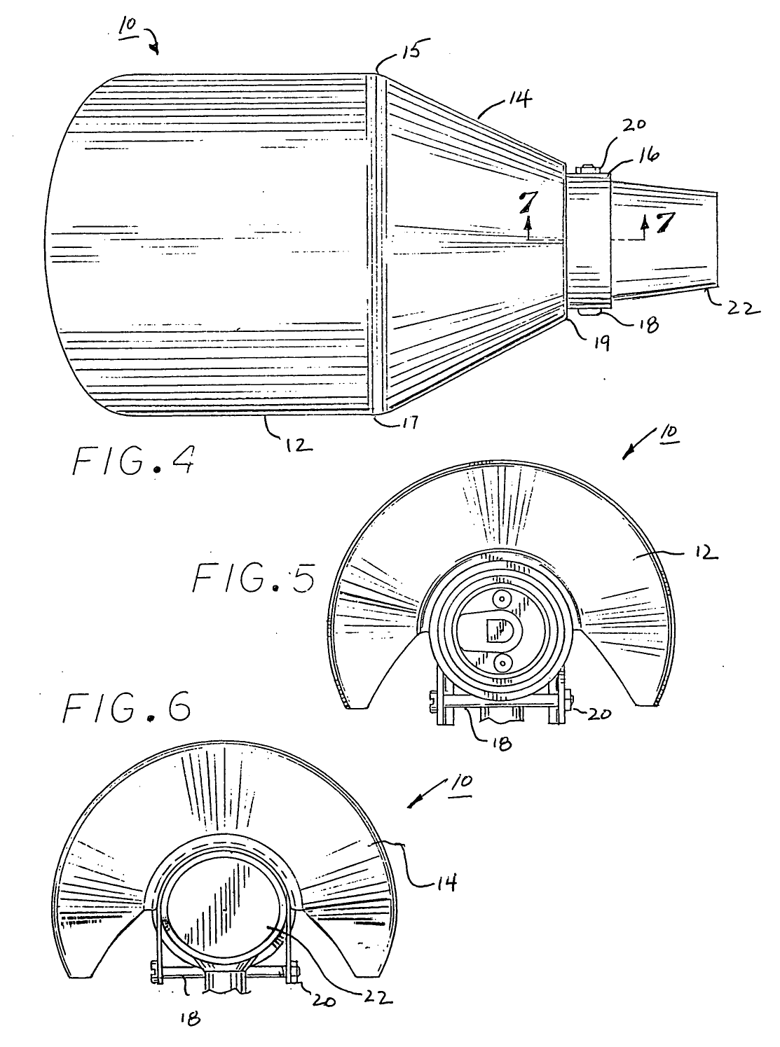

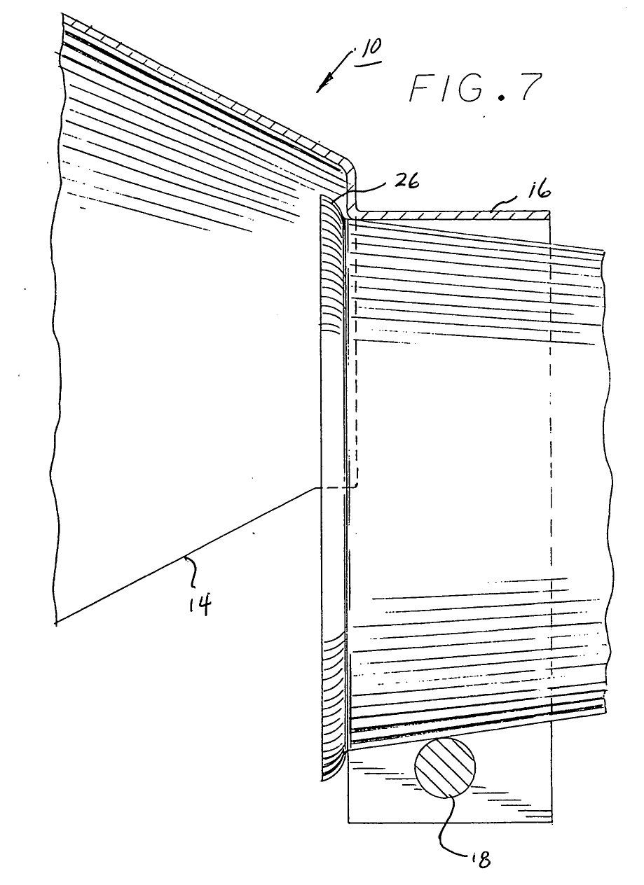

FIGS. 1-7 illustrate the light shield 10 of the present invention. Light shield 10 comprises a frustum-conical portion 12 having first and second ends 13 and 15, respectively, a cone shaped portion 14 having first and second ends 17 and 19, respectively, integral with portion 12 and a clamp strap 16 having a bolt 18 and nut 20. Clamp strap 16 is preferably integral with cone portion 14. Shown, but not part of the present invention, is light fixture 22. Although in the preferred embodiment, components 12, 14, and 16 are fabricated as an integral metal unit, each component can be separately fabricated and joined together using conventional techniques. In addition, the components can be fabricated from material other than metal. Light shield 10 is utilized to direct and refocus multi-directional light emitted by light fixture 22 in substantially the vertically downward direction as represented by arrows 24. In order to secure light shield 10 to fixture 22, portion 14 is positioned over flange portion 26 of fixture 22 as illustrated and then threaded bolt 18 is inserted through the openings formed in U-shaped legs 30 and 32 of strap 16 and nut 20 is secured to the threaded end of bolt 18.

The light shield of the present invention thus provides a simple, relatively inexpensive device for refocusing and redirecting light emitted from various light fixtures that are currently available.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A light shield comprising:
a first frustum-conical shaped portion;
a second cone shaped portion having first and second ends, said first end being integral with said first shaped portion; and
a clamp member adjacent said second end of said second cone shaped portion, said clamp member having a U-shape with first and second leg portions, said first and second leg portions having first and second openings formed therein.

2. The light shield of clamp I wherein said clamp member is positioned over a light fixture.

3. The light shield of claim 2 further including a bolt member positioned through said first and second openings.

4. The light shield of claim 3 wherein said first frustum-conical portion, said second cone portion and said clamp member are fabricated as an integral member.
